(19) United States
(12) Patent Application Publication
(10) Pub. No.: US 2015/0089821 A1
(43) Pub. Date: Apr. 2, 2015

(54) EXTENDABLE POLE SYSTEM AND METHODS OF USING THE SAME

(71) Applicant: Kevin Troudt, Renton, WA (US)

(72) Inventor: Kevin Troudt, Renton, WA (US)

(73) Assignee: STRETTA, INC., Seattle, WA (US)

(21) Appl. No.: 14/344,044

(22) PCT Filed: Sep. 10, 2012
(86) PCT No.: PCT/US12/54519

§ 371 Date: Dec. 1, 2014

Related U.S. Application Data
(60) Provisional application No. 61/570,241, filed on Dec. 13, 2011.
(60) Provisional application No. 61/533,124, filed on Sep. 9, 2011.

(51) Int. Cl. B25G 3/22; B25G 1/04

(52) U.S. Cl. CPC B25G 3/22; B25G 1/04
USPC 30/519; 16/427; 403/322.4; 81/491; 30/517

(57) ABSTRACT

A pole system for holding a tool includes a manually activated mechanism, an extendable pole apparatus, and a clamp mechanism. The clamp mechanism includes a receiver with a locked configuration to retain a tool and a released configuration to release the tool. The pole apparatus operably couples the actuator mechanism to the clamp mechanism such that manual operation of the actuator mechanism causes operation of the tool.

### CROSS-REFERENCE TO RELATED APPLICATIONS

The present application claims priority under 35 U.S.C. §119(e) of U.S. Provisional Application No. 61/533,124, filed Sep. 9, 2011, and U.S. Provisional Application No. 61/570,241, filed Dec. 13, 2011, the disclosures of which are incorporated herein by reference in their entireties.

### TECHNICAL FIELD

This invention generally relates to tools and pole systems with clamp mechanisms capable of selectively receiving tools.

### BACKGROUND

Ladders are often used to access hard-to-reach places. In gardening and landscaping, ladders are often used to cut trees (e.g., cut tree limbs) and prune large bushes. Ladders are also used to spray the sides of houses or under roofs (e.g., to spray wasp nests under roofs) or otherwise hard-to-reach locations. Unfortunately, if a ladder is used on soft soil or uneven surfaces, the ladder may have a tendency to lean and a user may fall to the ground.

### SUMMARY

At least some embodiments are directed to extendable pole systems with clamp mechanisms capable of selectively receiving tools. Clamp mechanisms can be quick release mechanisms into which tools can be rapidly installed or removed. Clamp mechanisms can operably couple the tools to a gripper mechanism or other type of actuator. The tool (e.g., a pruner, a sprayer device, a saw device, clippers, etc.) can be held by the clamp mechanism carried at an end of a pole apparatus while the user stands on the ground. A user can safely use the tools to cut trees, prune large bushes, spray the side of houses, or the like. The tools can be conveniently replaced to perform different activities. A pole apparatus can be extended to access a wide range of locations, including hard-to-reach locations.

In some embodiments, a clamp mechanism includes a housing, a receiver, an arm, and a lever. The housing is coupleable to a pole apparatus (e.g., an extendable pole apparatus, a fixed length pole apparatus, etc.). The receiver has a locked configuration to retain a tool and an unlocked configuration to release the tool. The arm is pivotably coupled to the housing and moveable to allow movement of the receiver from the locked configuration to the unlocked configuration. The lever is pivotably coupled to the housing and also pivotably coupled to the arm. The lever can move the arm as the lever rotates with respect to the housing.

An arm pin, in some embodiments, couples the arm to the housing to define an arm axis of rotation. A lever pin couples the lever to the housing to define a lever axis of rotation. The arm axis of rotation is spaced apart from and is substantially parallel to the lever axis of rotation. When the lever rotates about the lever axis of rotation, the arm is moved away from or towards the receiver. In some embodiments, the arm is moved (e.g., reciprocally translated) to cause operation of the tool.

In some embodiments, a connector pin rotatably couples the lever to the arm. The connector pin is positioned between the arm axis of rotation and the lever axis of rotation. In certain embodiments, the connector pin is translationally fixed to the lever. At least a portion of the connector pin can extend through an elongated slot of the arm to allow a desired amount of translation of the lever with respect to the arm.

In some embodiments, a clamp mechanism is configured to mechanically couple an actuator mechanism (e.g., a gripper mechanism) of a pole apparatus to a tool retained by the clamp mechanism. A user can manually operate the actuator mechanism to operate the tool via the clamp mechanism. The clamp mechanism can include one or more pulleys, gears, piston assemblies, rods, lever mechanisms, combinations thereof, or other mechanical and/or electrical components that mechanically couple the gripper mechanism to the tool. When a user operates the actuator mechanism, the tool is actuated for convenient use.

A biasing device can be positioned within a channel of the receiver. The biasing device can cause disengagement of a catch of the receiver and a portion of the tool positioned within the clamp mechanism. In some embodiments, the biasing device includes one or more springs that push the receiver away from the catch of the tool. The tool can have other retaining feature(s).

A pole system for holding a tool can include a gripper mechanism, an extendable pole apparatus, and a clamp mechanism. In certain embodiments, the clamp mechanism includes a housing coupled to the pole apparatus, a receiver surrounded by the housing, and an arm. The receiver has a locked configuration to retain a tool and a released or unlocked configuration to release the tool. The pole apparatus operably couples the gripper mechanism to the clamp mechanism such that operation of the gripper mechanism causes operation of the tool. In some embodiments, the arm is rotatably coupled to the housing and moveable between a first position and a second position. The arm allows the receiver to move from the locked configuration to the released configuration as the arm rotates. A lever is rotatably coupled to the housing and is rotatably coupled to the arm to cause rotation of the arm.

In some embodiments, a saw device is coupleable to a pole assembly and includes a blade, a holder configured to be coupled to a pole assembly, (e.g., an extendable pole apparatus) and an adjustment mechanism. The blade is fixedly coupled to the holder when the adjustment mechanism is in a locked configuration. The blade is rotatably coupled to the holder when the adjustment mechanism is in a released configuration. The adjustment mechanism can be moved to different configurations by a gripper mechanism of the pole assembly.

The adjustment mechanism, in some embodiments, includes a slider with teeth that are engageable with teeth of the blade that are positioned within the holder. The blade teeth can extend from an end of the blade. The slider can be moved away from the blade to disengage the teeth and allow rotation of the blade relative to the holder. The slider can be linearly displaceable along a longitudinal axis of the holder. In some embodiments, the adjustment mechanism is mechanically coupled to the gripper mechanism and is movable between the locked configuration and the released configuration by operating the gripper mechanism and/or a clamp mechanism of the pole assembly.

The blade, in some embodiments, is rotatable relative to the holder about an axis of rotation. In certain embodiments, the blade can rotate an angle of at least 10 degrees, 50 degrees, 100 degrees, 180 degrees, 230 degrees, or 270 degrees. Other angles of rotation are also possible, if needed or desired. In some embodiments, the blade is freely rotatable about an axis of rotation defined by a pin at an angle equal to or greater than about 10 degrees when the adjustment mechanism is in the released configuration.

In some embodiments, a system comprises a pole assembly and a saw device. The pole assembly has a manually operable clamp mechanism. The saw device includes a blade and a holder. The holder is coupleable to the pole assembly. The blade is selectively movable relative to the holder in response to operation of the clamp mechanism. The saw device can be replaced with other tools. Thus, the pole assembly can be used to operate more than one tool.

The saw device, in some embodiments, includes a holder that connects the pole assembly to the blade. The holder can include one or more internal components that selectively lock and unlock the blade. In certain embodiments, when the gripper mechanism is actuated, the blade is freely rotatable relative to a holder. The gripper mechanism can be operated to lock the blade in the desired position.

In some embodiments, an extension pole apparatus comprises an extension pole, a tool on a distal end of the extension pole, and a pole actuator. The extension pole apparatus has (1) a first mode in which the tool can be moved directly by a user independent of the pole, which movement implements a normal functional operation of the tool, and (2) a second mode in which the tool is made to function indirectly by a user from the pole distal end by action of the pole actuator (e.g., a gripper mechanism). The tool functionally operates through movement of the pole actuator and can include a latch rod that is functionally connectible to the pole actuator, such that movement of the latch rod implements the tool. The latch rod extends slidably within a tool base. The tool base is mounted approximately axially to the extension pole distal end as the latch rod functionally connects to the pole actuator internal to the connected tool base and extension pole distal end such that the latch rod is protected from access outside of the connected tool base and extension pole distal end. The latch rod is within the tool base such that operation of the tool in the first mode does not cause the latch rod to move external to the base.

### BRIEF DESCRIPTION OF THE DRAWINGS

Non-limiting and non-exhaustive embodiments are described with reference to the following drawings. The same reference numerals refer to like parts or acts throughout the various views, unless otherwise specified.

FIG. 1 is an isometric view of an extendable pole system, in accordance with one embodiment.

FIG. 2A is an isometric view of a clamp mechanism with a lever for opening and closing the clamp mechanism.

FIG. 2B is a partial cross-sectional isometric view of the clamp mechanism of FIG. 2A.

FIG. 3 is a cross-sectional view of a clamp mechanism in a closed configuration.

FIG. 4 is a side elevational view of a tool ready to be coupled to the clamp mechanism.

FIG. 5 is a cross-sectional elevational view of a tool ready to be coupled to the clamp mechanism.

FIG. 6 is a side cross-sectional elevational view of the extendable pole system and the tool in a first position.

FIG. 7 is a side cross-sectional elevational view of the extendable pole system and the tool in a second position.

FIG. 8 is a side cross-sectional elevational view of the extendable pole system with the clamp mechanism in an open configuration.

FIG. 9 is an isometric view of a saw device.

FIG. 9A is an elevational view of a saw device with a movable blade.

FIG. 9B is a detailed partial cross-sectional view of an adjustment mechanism.

FIG. 9C is an elevational partial cross-sectional view of the adjustment mechanism of FIG. 9B.

FIG. 9D is an isometric view of a portion of a saw device. A portion of a holder is shown removed.

FIGS. 10 and 11 are isometric views of a sprayer device.

### DETAILED DESCRIPTION

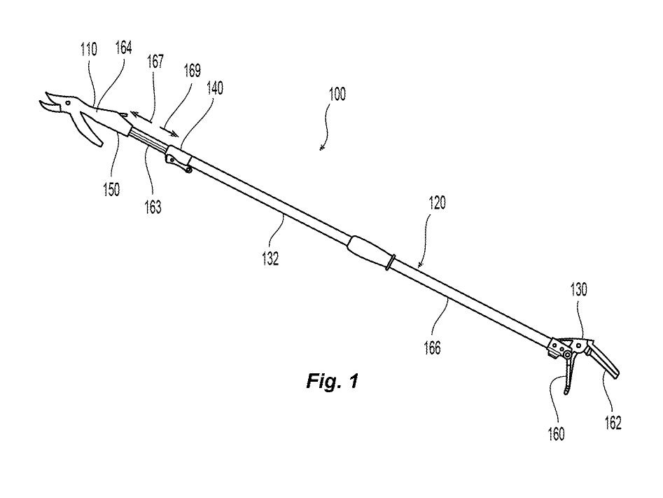

FIG. 1 shows an extendable pole system 100 that includes a tool in the form of a pruner 110 and a pole apparatus 120. The pole apparatus 120 includes a gripper or actuator mechanism 130, a clamp mechanism 150, and telescopic poles 132. A user can grip and squeeze handles 160, 162 to operate the pruner 110. The telescopic poles 132 can be extended so that the pruner 110 can access hard-to-reach places without the use of a ladder, if desired.

The clamp mechanism 150 can be a quick release mechanism that selectively receives and releases the pruner 110. To install the pruner 110, a base 164 of the pruner 110 can be pushed into the closed clamp mechanism 150. Internal components of the clamp mechanism 150 mechanically connect the gripper mechanism 130 to the pruner 110 such that operation of the gripper mechanism 130 causes operation of the pruner 110.

The pruner 110 can operate in more than one mode of operation. In a first mode, the pruner 110 can be moved independent of operation of the pole apparatus 120. In the illustrated embodiment, a user can squeeze the pruner handles together to cut an item (e.g., a branch) between the pruner's blades when the pruner 110 is coupled to or separated from the clamp mechanism 150. The pruner 110 can thus be operated in a manner independent of whether the pruner 110 is attached to the pole apparatus 120. In a second mode of operation, the pruner 110 is coupled to the pole apparatus 120 and mechanically coupled to the gripper mechanism 130. Movement of the handles 160, 162 generally corresponds to movement of the handles of the pruner 110 such that a user can remotely manually operate the pruner 110.

With continued reference to FIG. 1, the telescopic poles 132 include an outer pole 166 and an inner pole 168 disposed in a lumen of the outer pole 166. The inner pole 168 can slide relative to the outer pole 166, as indicated by arrows 167, 169, to adjust the length of the telescopic poles 132. For example, the pole 166 can be moved distally, as indicated by arrow 167, to increase the length of the pole apparatus 120. The poles 166, 168 can be made, in whole or in part, of one or more metals, polymers, fiberglass, plastic, and the like. The lengths and configurations of the poles 166, 168 can be selected to achieve the desired mechanical properties (e.g., stiffness, weight, etc.). For example, the poles 166, 168 can be hollow tubes made of plastic or metal. A locking mechanism 140 can selectively lock the hollow poles 166, 168 together. In other embodiments, the telescopic poles 132 can include more than two poles and additional locking mechanisms can lock the poles together.

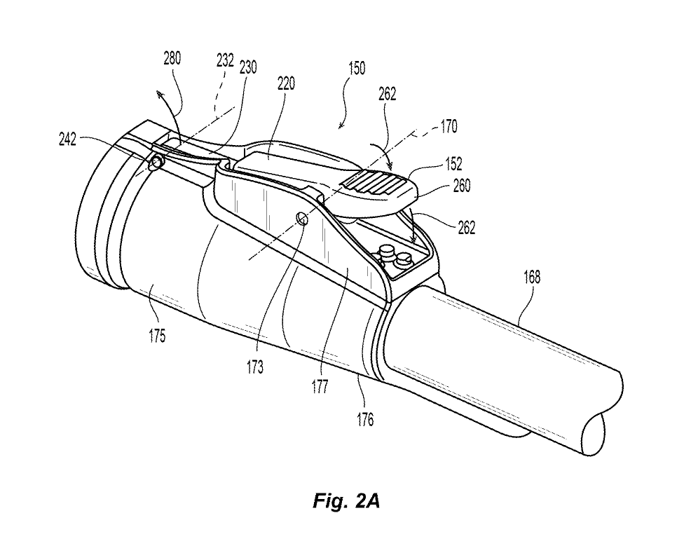

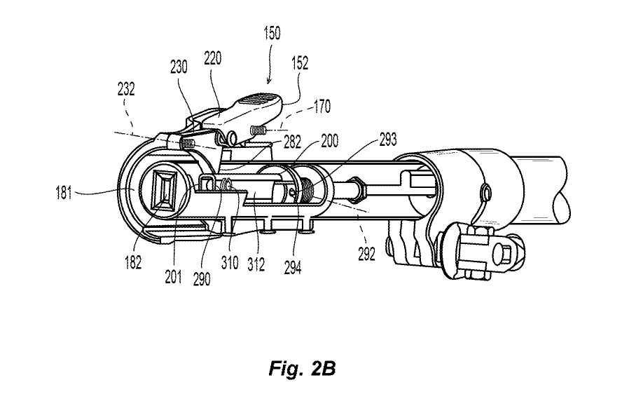

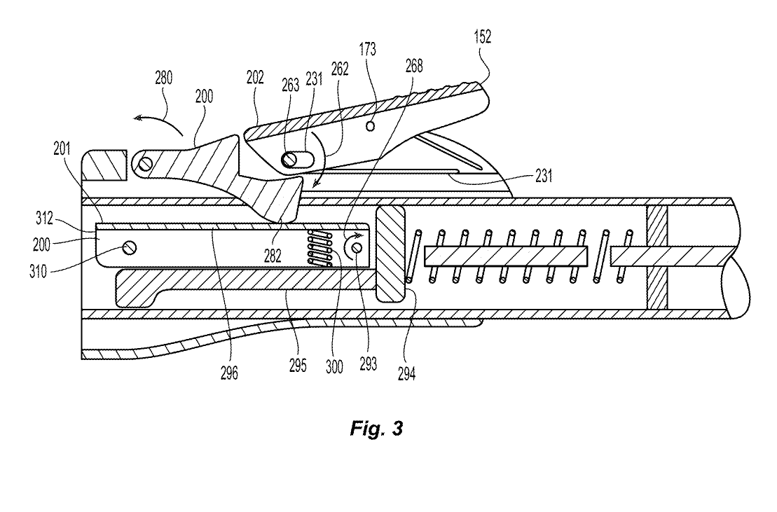

FIG. 2A shows a housing 175 including a proximal end 176 fixedly coupled to the end of the inner pole 168. A bracket 177 holds a pin 173 that defines a lever axis of rotation 170. A pin 242 is coupled to the housing 175 and defines an arm axis of rotation 232. A biasing member 231 (see FIGS. 3 and 5) can bias the lever 152 towards the illustrated closed position.

FIGS. 2A and 2B shows a rotatable arm 230 that contacts and keeps a receiver 200 in a locked configuration. As the lever 152 rotates about the axis of rotation 170, the arm 230 rotates about the arm axis of rotation 232. The receiver 200 rotates about a receiver axis of rotation 292. A distal end 201 of the receiver 200 moves towards a released or disengagement position. A biasing device 300 (see FIG. 3) can cause such rotation and can include, without limitation, one or more springs, including helical springs, coil springs, or the like.

FIGS. 2B and 3 show internal components of the clamp mechanism 150. The receiver main body 312 is a generally U-shaped, elongate body rotatable about the axis of rotation 292, as indicated by an arrow 268 of FIG. 3. A pin 293 defines the axis of rotation 292 and is coupled to a head 294. The biasing device 300 is positioned generally between the pin 293 and a catch 310. In some embodiments, including the illustrated embodiment of FIG. 3, the biasing device 300 extends between a base member 295 and an upper portion 296 (FIG. 3) of the receiver 200. The biasing device 300 pushes against the upper portion 296 to cause rotation of the receiver 200 about the axis of rotation 292.

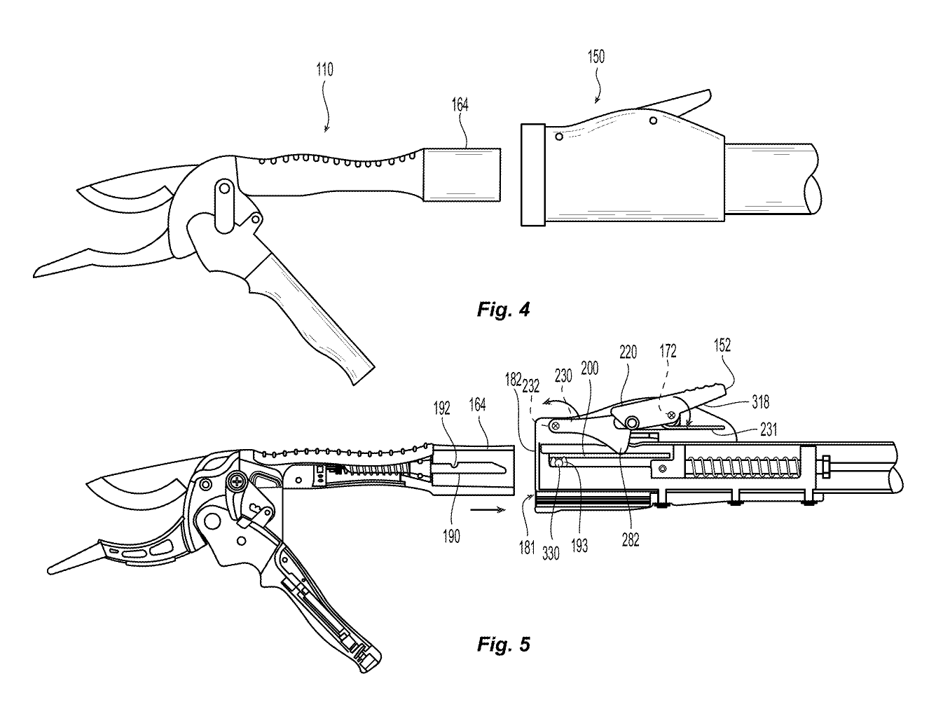

FIGS. 4 and 5 show the pruner 110 ready to be coupled to the clamp mechanism 150. Referring to FIG. 5, a rod 190 extends through the base 164 (illustrated as a tubular base) and includes a retaining feature 192 (e.g., a notch, a protrusion, or the like). The base 164 can be inserted into an annular opening 181. The rod 190 is inserted through an opening 182 (see FIG. 2B) until a retaining feature 192 physically engages a catch 193. When the catch 193 moves into the retaining features 192, a user can hear an audible indicator (e.g., a click noise). In some embodiments, a click noise can confirm when the pruner 110 is properly installed.

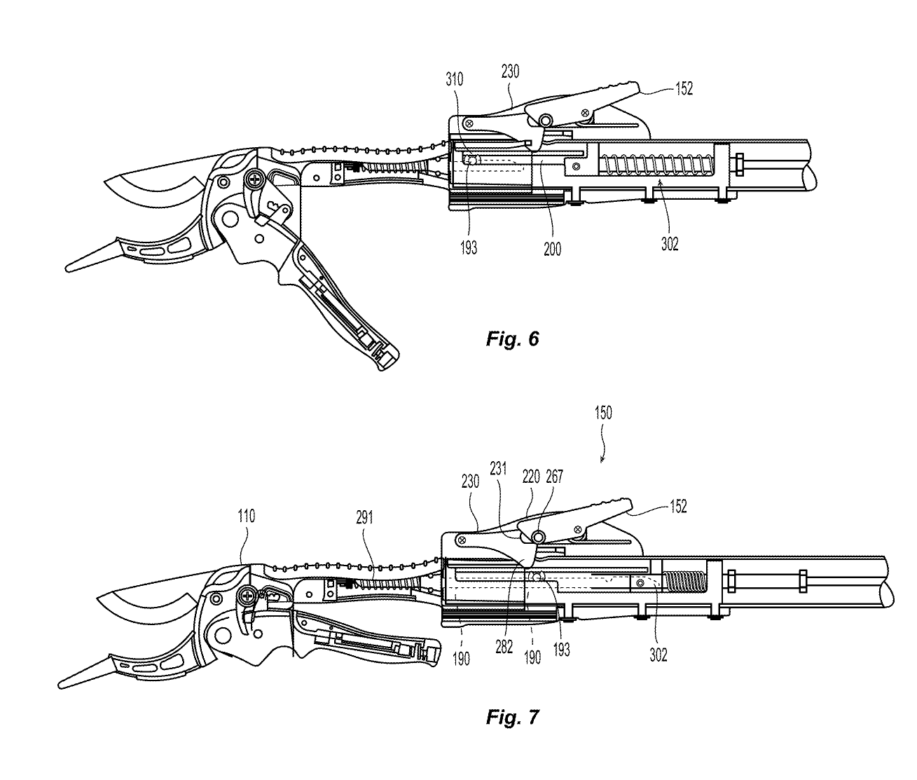

FIG. 6 shows the rod 190 (illustrated in dashed line) is retained by the catch 193. The arm 230 presses down on the receiver 200. A piston assembly 302 can be moved proximally from an initial position shown in FIG. 6 to a final position shown in FIG. 7. A head 294 can pull the rod 190 to close the pruner 110. The head 294 can be moved distally to open the pruner 110.

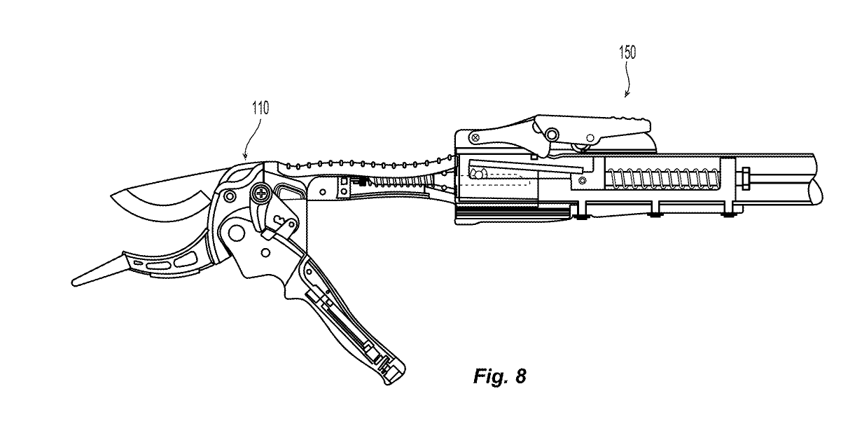

Referring again to FIGS. 2A and 3, to release the pruner 110, lever 152 can be rotated about the axis of rotation 170, as indicated by an arrow 262 in FIG. 2A. An end 202 of the lever 152 moves upwardly, causing a pin 267 to slide in a slot 234 of the arm 230. This causes rotation of the arm 230 about the axis of rotation 232, as indicated by an arrow 280 in FIG. 2A. An abutment portion 282 (FIG. 3) can move upwardly and away from the rod 190. The biasing device 300 can cause rotation of the receiver 200, and the catch 193 can be pushed out of the receiving feature 192. Once the catch 193 is out of the receiving feature 192, the pruner 110 can be separated from the clamp mechanism 150. FIG. 8 shows the clamp mechanism 150 in an open configuration to allow removal of the pruner 110. After removing the tool, the clamp mechanism 150 can be returned to the closed configuration to install another tool.

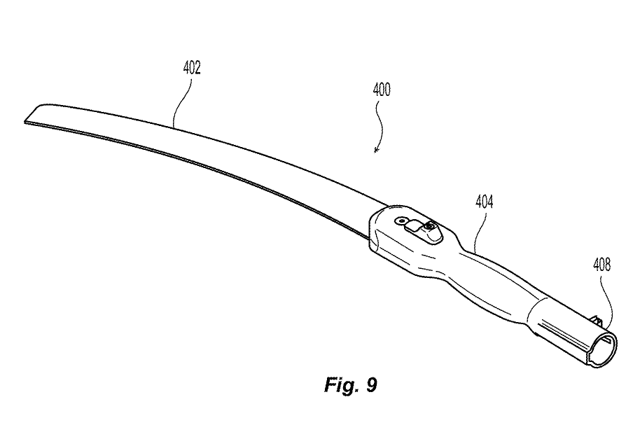

FIG. 9 shows a tool in the form of a saw device 400 including a blade 402 coupled to a holder 404. The holder 404 defines a handle that can be gripped by a user to manually use the saw device 400. The blade 402 can have teeth for cutting through limbs of trees. The holder 404 has a connector 408 that can be selectively held by a clamp mechanism.

FIG. 9A shows an adjustment mechanism 406 between the holder 404 and the blade 402. FIG. 9B shows the adjustment mechanism 406 in a locked configuration to hold the blade 402 in a first position. FIG. 9C shows the blade 402 locked in a second position 412. FIG. 9D shows internal components of the saw device 400.

Referring to FIG. 9A, the blade 402 can be moved between, for example, a first position 410 and a second position 412 (illustrated in dashed line) when the adjustment mechanism is in a released configuration. When the holder 404 is connected to a clamp mechanism (or other component of pole apparatus), the user can operate a gripper or actuator mechanism to selectively release and lock the blade 402.

Referring to FIG. 9B, the adjustment mechanism 406 is in a locked configuration and includes a slider 414 having teeth 416. The teeth 416 enmesh with blade teeth 418. The slider 414 can be moved away from the blade 402, as indicated by an arrow 420. When the teeth 416 disengage the teeth 418, the blade 402 can be rotated about an axis of rotation 433 (see FIG. 9D) defined by a pin 422. For example, when the adjustment mechanism 406 is moved to a released configuration, the blade 402 can be rotated about the axis of rotation 433 an angle, for example, of at least 10 degrees, 15 degrees, 30 degrees, 90 degrees, 130 degrees, 180 degrees, 230 degrees, or other desired angles. When the blade 402 is in a desired position, the slider 414 can be returned to the locked position, as indicated by an arrow 421 of FIG. 9C.

Referring to FIG. 9C, the slider 414 is in a locked position to keep the blade 402 in the second position 412. Even when significant forces are applied to the blade 402, the blade 402 remains fixed relative to holder 404.

FIG. 9D shows the slider 414 that can be moved proximally by pulling on a rod 443 of a piston assembly 441. A user can operate a gripper mechanism to displace the slider 414. An end 445 of the rod 443 can be fixedly coupled to the slider 414. After the slider 414 is moved proximally, the blade 402 can be moved to a desired position relative to the holder 404. Once the blade 402 is in the desired position, the slider 414 can move distally to engage and lock the blade 402. A biasing member 447 can contact an abutment 449 and urge the slider 414 distally to enmesh the teeth 416, 418. In some embodiments, the slider 414 can automatically engage the blade 402 when the gripper mechanism is released.

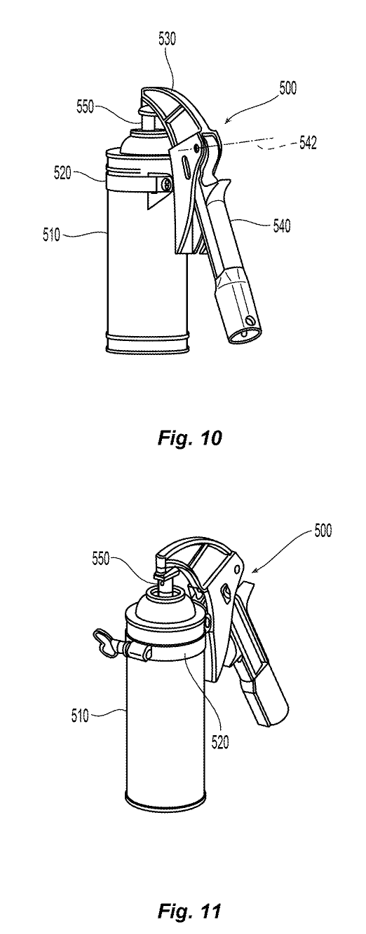

FIGS. 10 and 11 show a sprayer device 500 configured to operate a spray canister 510. The sprayer device 500 includes a holder 520, illustrated as a retaining band that surrounds and securely holds the canister 510. A head 530 is rotatably mounted to a connector 540. The head 530 can rotate about an axis of rotation 542 to press down on a nozzle 550. The connector 540 can be installed in a clamp mechanism. A gripper mechanism can be operated to push down on a spray nozzle via the head 530.

As used herein, the term “tool” is a broad term that includes, without limitation, a saw, a pruner, a gardening tool, a sprayer device, or other type of tool that is often used at hard-to-reach locations. Additionally, different types of actuating mechanisms, engagement features (e.g., teeth, pins, or the like), and the like can be used to move components of tools. By way of example, clamps, pins, and/or other features can be used to, for example, lock, release, or otherwise reposition a blade. Where the context permits, singular or plural terms may also include the plural or singular term, respectively. Unless the word “or” is associated with an express clause indicating that the word should be limited to mean only a single item exclusive from the other items in reference to a list of two or more items, then the use of “or” in such a list shall be interpreted as including (a) any single item in the list, (b) all of the items in the list, or (c) any combination of the items in the list. The singular forms “a,” “an,” and “the” include plural referents unless the context clearly indicates otherwise.

U.S. Provisional Application No. 61/533,124, U.S. Provisional Application No. 61/570,241, and U.S. Pat. No. 8,060,987 (application Ser. No. 11/832,046), issued on Nov. 22, 2011, are incorporated herein by reference in their entireties. The embodiments, components, features, systems, devices, methods and techniques described herein may, in some embodiments, be similar to any one or more of the embodiments, features (e.g., tools, mechanical connectors, mechanical connections, etc.), systems, devices, materials, methods and techniques described in U.S. Pat. No. 8,060,987 and U.S. Provisional Application Nos. 61/533,124 and 61/570,241. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned U.S. Pat. No. 8,060,987 and Provisional Application Nos. 61/533,124 and 61/570,241. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

I/We claim:

1. A clamp mechanism for operably coupling a tool to a pole apparatus, comprising:
a housing coupleable to a pole apparatus;
a receiver within the housing, the receiver having a locked configuration to retain a tool and a released configuration to release the tool;
an arm pivotally coupled to the housing and movable between a first position and a second position, wherein the arm is configured to allow the receiver to move from the locked configuration to the released configuration as the arm moves from the first position to the second position; and
a lever pivotally coupled to the housing and pivotally coupled to the arm, the lever is configured to move the arm from the first position to the second position as the lever rotates with respect to the housing.

2. The clamp mechanism of claim 1, wherein the clamp mechanism is configured to mechanically couple a manual actuator mechanism of the extendable pole apparatus to operate a tool retained by the clamp mechanism.

3. The clamp mechanism of claim 1, further comprising:
an arm pin coupling the arm to the housing to define an arm axis of rotation; and
a lever pin coupling the lever to the housing to define a lever axis of rotation, and the arm axis of rotation is spaced apart from and substantially parallel to the lever axis of rotation.

4. The clamp mechanism of claim 3, further comprising a connector pin rotatably coupling the lever to the arm, wherein the connector pin is positioned between the arm axis of rotation and the lever axis of rotation.

5. The clamp mechanism of claim 1, further comprising a connector pin that rotatably couples the lever to the arm, and the arm has an elongated slot through which the connector pin extends.

6. The clamp mechanism of claim 1, further comprising a biasing device positioned within a channel of the receiver and configured to cause disengagement of a catch of the receiver and a portion of the tool positioned within the clamp mechanism.

7. A pole system, comprising:
a gripper mechanism;
a pole apparatus; and
the clamp mechanism of claim 1 coupled to the pole apparatus to operably coupled a tool held by the clamp mechanism to the gripper mechanism.

8. A pole system for holding a tool, comprising:
a gripper mechanism;
a pole apparatus; and
a clamp mechanism, including:
a housing coupled to the pole apparatus;
a receiver within the housing, the receiver having a locked configuration to retain a tool and a released configuration to release the tool, the pole apparatus operatably coupling the gripper mechanism to the clamp mechanism such that operation of the gripper mechanism causes operation of the tool;
an arm pivotally coupled to the housing and movable between a first position and a second position, the arm allowing movement of the receiver from the locked configuration to the released configuration as the arm moves from the first position towards the second position; and
a lever pivotally coupled to the housing and pivotally coupled to the arm, the lever moves the arm from the first position to the second position as the lever rotates relative to the housing.

9. The pole system of claim 8, wherein the gripper mechanism includes movable handles that cause corresponding operation of the tool when the movable handles are moved towards one another.

10. A saw device coupleable to a pole assembly, the saw device comprising:
a blade;
a holder configured to be coupled to a pole assembly; and
an adjustment mechanism having a locked configuration and a released configuration, the blade is fixedly coupled to the holder when the adjustment mechanism is in the locked configuration, and the blade is rotatably coupled to the holder when the adjustment mechanism is in the released configuration.

11. The saw device of claim 10, wherein the adjustment mechanism includes a slider with teeth that are engageable with teeth of the blade positioned in the holder.

12. The saw device of claim 10, wherein the blade is rotatable relative to the holder and about an axis of rotation an angle of at least 10 degrees when the adjustment mechanism is in the released configuration.

13. A system comprising:
a pole assembly having a gripper mechanism; and
a saw device detachably coupled to the pole assembly, the saw device including a blade and a holder coupled to the pole assembly, the blade being selectively movable relative to the pole assembly in response to manual operation of the gripper mechanism.

14. The system of claim 13, further comprising an adjustment mechanism having a locked configuration and a released configuration, the blade is fixedly coupled to the holder when the adjustment mechanism is in the locked configuration, and the blade is rotatably coupled to the holder when the adjustment mechanism is in the released configuration.

15. The system of claim 14, wherein the adjustment mechanism is mechanically coupled to the gripper mechanism and is movable between the locked configuration and the released configuration by operating the gripper mechanism and/or a clamp mechanism of the pole assembly.

16. The system of claim 14, wherein the adjustment mechanism includes a slider with teeth that are engageable with teeth of the blade positioned in the holder.

17. The system of claim 13, wherein the blade is rotatable relative to the holder at an angle of at least 10 degrees.
